(19) United States
(12) Patent Application Publication
(10) Pub. No.: US 2013/0244701 A1
(43) Pub. Date: Sep. 19, 2013

(54) DRIVE INFORMATION NOTIFICATION SYSTEM

(71) Applicant: PEI-CHENG CHIU, Kaohsiung (TW)

(72) Inventor: PEI-CHENG CHIU, Kaohsiung (TW)

(21) Appl. No.: 13/421,841

(22) Filed: Mar. 15, 2012

(51) Int. Cl. H04W 4/00

(52) U.S. Cl. 455/466

(57) ABSTRACT

A drive information notification system includes at least a MCU processor, an equipment signal modulation module, a radio transmitter/receiver device, an ACC power control device, and a power stabilization device. The MCU processor is connected to at least one of an ECU vehicle computer, a controller area network, a local interconnect network, and electrical control signal sources of equipments/devices of the vehicle to retrieve drive information of the vehicle for subsequent processing and uses the radio transmitter/receiver device to transmit the drive information to be received by a corresponding intelligent mobile phone to allow the intelligent mobile phone to make a notification through graphics, text, or voice.

### TECHNICAL FIELD OF THE INVENTION

The present invention generally relates to a drive information notification system, and more particularly to a notification system that makes instantaneous notification of information of equipments of a vehicle to a remote site to be recorded.

### DESCRIPTION OF THE PRIOR ART

A vehicle often includes a variety of devices and equipments. Through normal operations of these devices and equipments, a vehicle may make full use of its functions for operation. However, all the devices and equipments have their own lifespan and may also get unexpected malfunction so as to affect drive safety of the vehicle. Monitoring the normality of the devices and equipments of the vehicle is important in ensuring normal operation of the vehicle and allows immediate repair or replacement once a device or equipment gets broken in order to ensure the normal operability of the devices and equipments of the vehicle thereby realizing drive safety.

Traditionally, once the devices or equipments of a vehicle get broken down, indicators of the vehicle may get lit for notification or professional mechanics may make certain inspection to identify the malfunction. However, a vehicle includes a great number of devices and equipments and it is generally insufficient for identifying all malfunctioning of these devices and equipment simply through the malfunction indicators of the vehicle. Having professional mechanics of garages to make inspections is generally very time consuming and this is, at least to some extents, troublesome and inconvenient for the drivers or vehicle owners.

Thus, a major challenge of the automobile industry is to provide a measure that is operable to make instantaneous notification and displaying of all the information associated with various devices and equipments of a vehicle so as to have the information be noted and identified.

### SUMMARY OF THE INVENTION

The present invention provides a drive information notification system, which allows drive information of a vehicle to be reported and thus get aware, whereby the driver or vehicle owner may instantaneously know each piece of drive information of the vehicle to ensure drive safety.

Thus, the present invention provides a drive information notification system. The system of the present invention comprises an MCU processor, an equipment signal modulation module, a radio transmitter/receiver device, an ACC power control device, and the power stabilization device. The MCU processor according to the present invention is connected with an ECU vehicle computer, a controller area network (CAN), a local interconnect network (LIN), and electrical control signal sources of equipments/devices of the vehicle to retrieve vehicle information of the ECU vehicle computer and vehicle information in the transmission of the CAN and the LIN, and electrical control signals of the operation of the vehicle equipments/devices. The MCU processor processes the retrieved drive information. The MCU processor is also connected with a radio transmitter/receiver device for outward transmission of the vehicle information after being processed by the MCU processor and for receiving external radio signals. Thus, the information of the ECU vehicle computer, the CAN, the LIN, or the electrical control signal of the operation of the vehicle equipments/devices is continuously transmitted outward through the radio transmitter/receiver device and a corresponding intelligent mobile phone receives the information transmitted by the radio transmitter/receiver device to allow graphic under interface (GUI) of the intelligent mobile phone to instantaneously display the vehicle information, allowing a driver or vehicle own to instantaneously realize the condition of the vehicle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is block diagram of the present invention.

FIG. 2 is a block diagram schematically illustrating an application of the present invention.

FIG. 3 is a block diagram illustrating another embodiment of the present invention.

FIG. 4 is a block diagram illustrating a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

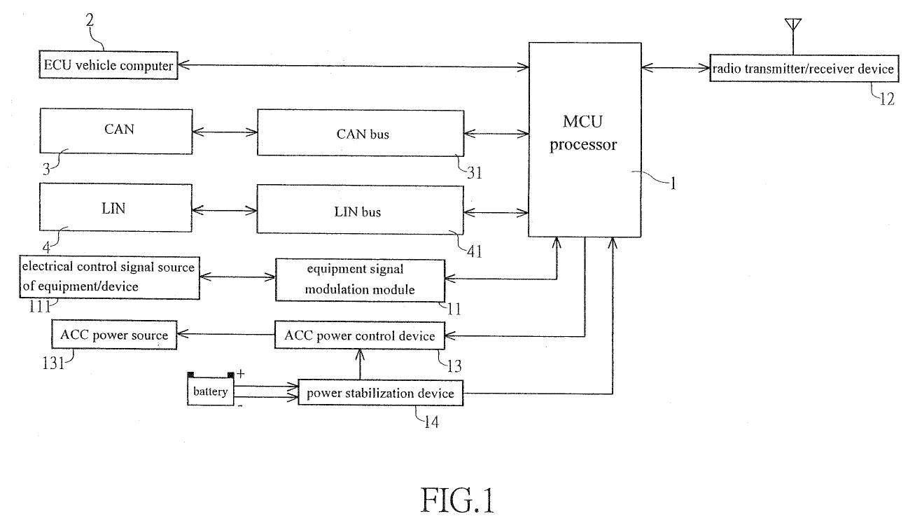

Referring to FIG. 1, the present invention provides a drive information notification system, which comprises at least a MCU processor 1, an equipment signal modulation module 11, a radio transmitter/receiver device 12, an ACC power control device 13 and a power stabilization device 14.

The MCU processor 1 is connected, through an on-board diagnosis system, such as On-Board Diagnosis II (OBD-II), to an ECU vehicle computer 2 of the vehicle and is also connected through a controller area network (CAN) bus 31 to CAN 3, and is also connected through a local interconnect network (LIN) bus 41 to LIN 4 so as to access and retrieve vehicle drive information of the ECU vehicle computer 2 and all vehicle drive information in the transmission of the CAN 3 and LIN 4. On the other hand, the MCU processor 1 is connected through the equipment signal modulation module 11 to an electrical control signal source 111 of an equipment/device of the vehicle to be set in order to access and retrieve signal information of the operation of the equipment/device of the vehicle that is so set. The MCU processor 1 processes all the drive information of the vehicle so retrieved. The MCU processor 1 is connected to a radio transmitter/receiver device 12. The radio transmitter/receiver device 12 transmits outward the vehicle information that has been processed by the MCU processor 1 and receives radio signal from the external and transmits the received radio signal to the MCU processor 1. The MCU processor 1 receives electrical power from the vehicle battery and is provided with an ACC power control device 13 that is connected to an ACC power source 131 provided by the vehicle so as to obtain the necessary power from the vehicle battery power source and the ACC power source 131. The MCU processor 1 is also connected to a power stabilization device 14 in order to make the used power subjected to stabilization operation and thus maintaining normal operation of the present invention.

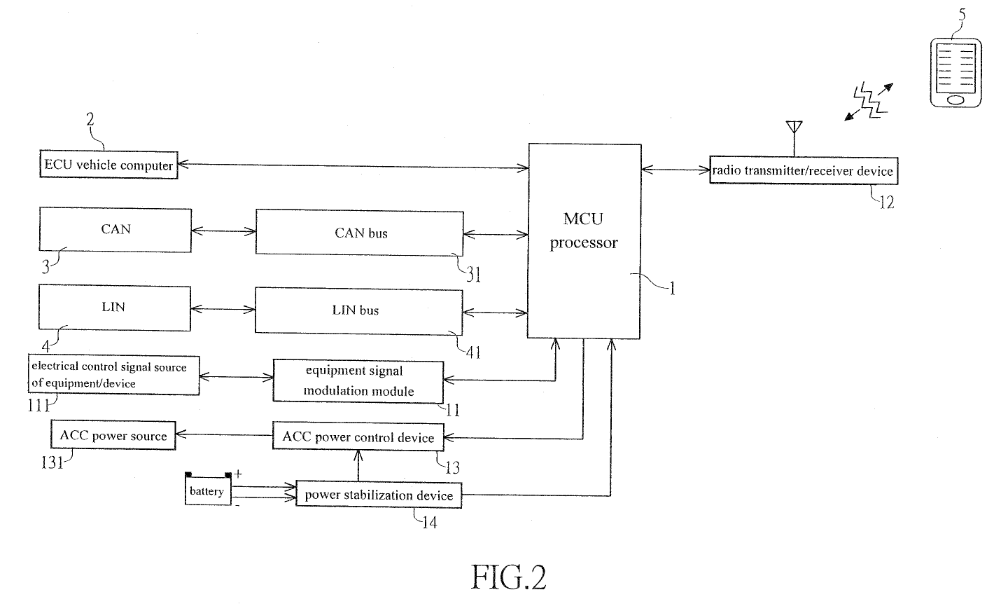

To use, as shown in FIG. 2, all equipments and devices of the vehicle are automatically put into operation when the vehicle is being driven or are intentionally activated. These equipments/devices, due to being put into operation, generate vehicle drive information that is output through the ECU vehicle computer 2 or transmitted through the CAN 3 and/or the LIN 4 and is transmitted among the electrical control signal sources 111 of various equipments/devices and the information may get updated timely. The present invention uses the connection of the MCU processor 1 with the ECU vehicle computer 2, the CAN 3, the LIN 4, or the electrical control signal sources 111 of the equipments/devices to have the drive information of the ECU vehicle computer 2, the CAN 3, the LIN 4 or the electrical control signal sources 111 of the equipments/devices processed and subsequently and constantly transmitted outward through the radio transmitter/receiver device 12 to be received by an intelligent mobile phone 5 so that the intelligent mobile phone 5 may display the drive information in graphic or text form for notification or to broadcast with voice for notification.

A user interface of a regular intelligent mobile phone 5 is constituted by various text and graphic. The most commonly known interface is graphical user interface (GUI). By providing a communication protocol between the radio transmitter/receiver device 12 and the intelligent mobile phone 5, the drive information of the vehicle can be received by the intelligent mobile phone 5 and the intelligent mobile phone 5 may downward, through the Internet, the GUI for displaying purposes so that the vehicle information can be displayed on the intelligent mobile phone 5 with corresponding graphics or text to allow a driver or vehicle owner to get instantaneously aware of the status of the vehicle. Sound broadcasting may also be made through application software downloaded through the Internet by the intelligent mobile phone 5, so that the intelligent mobile phone 5 may provide alarm sound or voice broadcasting of the contents of the drive information. The drive information can be filed and stored in or by the intelligent mobile phone 5 for subsequent access by other card readers to provide history of the vehicle drive information that might be helpful in vehicle maintenance and repair.

The radio communication between the radio transmitter/receiver device 12 of the MCU processor 1 and the intelligent mobile phone 5 can be any one selected from Bluetooth, 2.4G communication, 3G communication, 5G communication, Wi-Fi, radio frequency (RF), ZigBee, MiWi, and Sud-GHz.

It is noted that besides being connected to the battery power source of the vehicle, the present invention is also connected through the ACC power control device 13 to the ACC power source 131 of the vehicle.

Thus, when the engine of the vehicle is in operation, the power generator of the vehicle supplies electrical power to be used by the present invention in order to maintain normal operation.

When the vehicle engine is shut down, the ECU vehicle computer 2, the CAN 3, and the LIN 4 all enter a shut-down statue or a standby status and thus, the information retrieved at this moment is exactly the final information before the engine is shut down. New information, such as battery capacity and tire pressure, caused by natural loss or malfunctioning cannot be obtained after the engine is shut down. Under this condition, the intelligent mobile phone 5 may be operated to transmit a signal to be received by the radio transmitter/receiver device 12 connected to the MCU processor 1 in order to wake up the MCU processor 1 of the present invention for conducting information processing. The MCU processor 1 signals the ACC power control device 13 to conduct on the ACC power source 131 to allow the ECU vehicle computer 2, the CAN 3, and the LIN 4 of the vehicle to temporarily resume operation so that the new information may be received by the MCU processor 1 and the MCU processor 1 may then output the new information of the vehicle to allow the corresponding the intelligent mobile phone 5 to make an instantaneous notification.

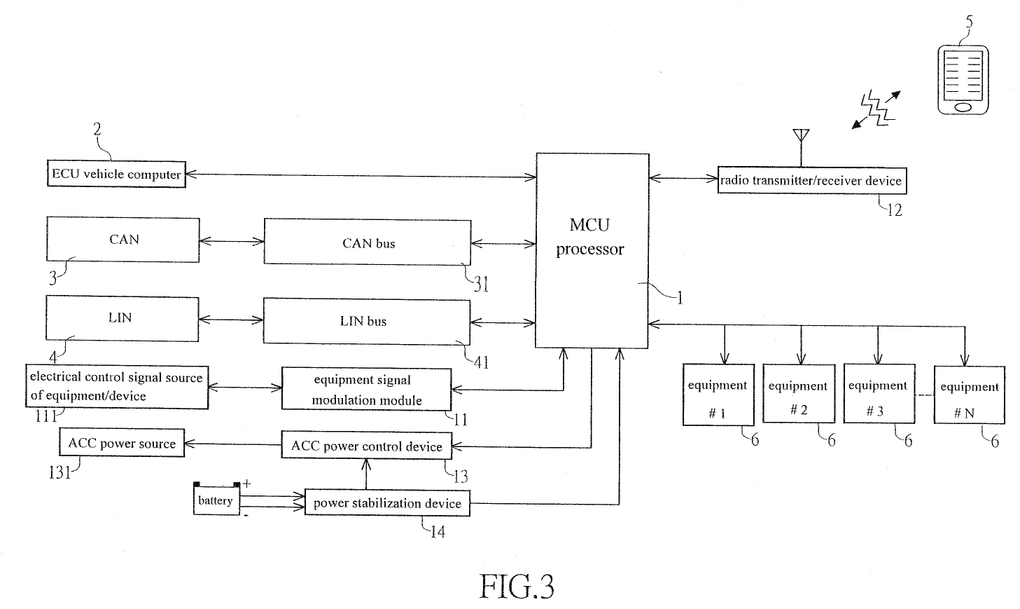

In another embodiment of the present invention, as shown in FIG. 3, when the vehicle is additionally installed with other equipments, an additional equipment 6 is mounted to the vehicle. The additional equipment 6 is made electrically connected to the MCU processor 1 of the present invention and a communication protocol is established between the additional equipment 6 and the MCU processor 1 of the present invention, whereby information from the additional equipment 6 may also be transmitted to the MCU processor 1 to be processed by the MCU processor 1 and subsequently transmitted by the radio transmitter/receiver device 12 to the intelligent mobile phone 5 and thus a notification in either graphics, text, or voice can be made by the intelligent mobile phone 5.

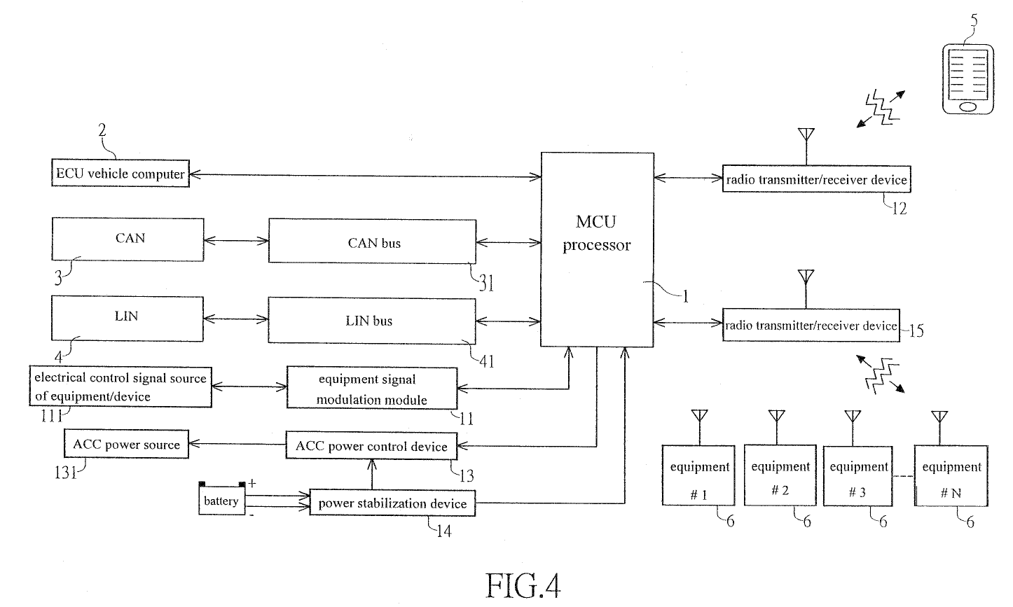

In a further embodiment of the present invention, as shown in FIG. 4, if the additional equipment 6 of the vehicle is operated to transmit information with radio transmission, such as a tire pressure monitor system (TPMS), the MCU processor 1 of the present invention may be provided with another radio transmitter/receiver module 15, so that the radio transmitter/receiver module 15 may establish a communication protocol with the radio signals of the additional equipment 6 to allow the radio signals of the additional equipment 6 to be received by the radio transmitter/receiver module 15 of the MCU processor 1, processed by the MCU processor 1, and transmitted outward by the radio transmitter/receiver device 12 to be received by a corresponding intelligent mobile phone 5 and thus a notification in either graphics, text, or voice can be made by the intelligent mobile phone 5.

The efficacy of the present invention is that the MCU processor 1 of the present invention is connected with an ECU vehicle computer 2 of a vehicle and is connected with CAN 3 and LIN 4, and is connected to electrical control signal sources 111 of equipments/devices of the vehicle in order to access and retrieve vehicle drive information of the ECU vehicle computer 2, all vehicle drive information in the transmission of the CAN 3 and LIN 4, and signals of the electrical control signal sources 111 of various equipments/devices of the vehicle. The MCU processor 1 is also connected to a radio transmitter/receiver device 12 in order to transmit outward the vehicle information obtained by the MCU processor 1 and receive radio signal from the external. The information of the MCU processor, the CAN 3 and the LIN 4 are continuously transmitted outward through the radio transmitter/receiver device 12 and a corresponding intelligent mobile phone 5 receives the information transmitted from the radio transmitter/receiver device 12 so that the intelligent mobile phone 5 may instantaneously display the vehicle information with the GUI or to broadcast with voice through the intelligent mobile phone 5. Through the notification made for the drive information, the driver or the vehicle owner can realize the instantaneous condition of the vehicle and the information can be stored in or by the intelligent mobile phone 5 for subsequent access by other card readers to provide history of the vehicle drive information that might be helpful in vehicle maintenance and repair.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A drive information notification system, comprising:
a microcontroller unit (MCU) processor, which is connected to an electronic control unit (ECU) vehicle computer and at least one of a controller area network (CAN), a local interconnect network (LIN), and electrical control signal sources of equipments/devices of a vehicle to retrieve drive information of the vehicle for subsequent processing;
a radio transmitter/receiver device, which is connected to the MCU processor to transmit outward the drive information received from the MCU processor to be received by an intelligent mobile phone, so that the intelligent mobile phone make notification of the drive information through displaying and broadcasting;
an ACC power control device, which is connected to an ACC power source of the vehicle to selectively conduct on the ACC power source for subsequent use; and
a power stabilization device, which carries out voltage regulation of the electrical power used in order to maintain normal operation of the system.

2. The drive information notification system according to claim 1, wherein the radio transmitter/receiver device and the intelligent mobile phone establish communication protocol therebetween to allow the information of the vehicle to be received by the intelligent mobile phone.

3. The drive information notification system according to claim 2, wherein radio communication between the radio transmitter/receiver device and the intelligent mobile phone is any one selected from Bluetooth, 2.4G communication, 3G (Third Generation) communication, 5G (Fifth Generation) communication, Wi-Fi, radio frequency (RF), ZigBee, MiWi, and Sud-GHz.

4. The drive information notification system according to claim 1, wherein the intelligent mobile phone downward, through the Internet, a graphical user interface (GUI) for displaying so that the drive information of the vehicle is displayed on the intelligent mobile phone with corresponding graphics or texts for realizing notification.

5. The drive information notification system according to claim 1, wherein the intelligent mobile phone download through the Internet application software so that the drive information of the vehicle is notification through voice broadcasting by the intelligent mobile phone for realizing notification.

6. The drive information notification system according to claim 1, wherein when the vehicle engine is shut down, the radio transmitter/receiver device receives a signal from the intelligent mobile phone to wake up the MCU processor from a standby state to an active state for carrying out processing operation.

7. The drive information notification system according to claim 6, wherein after the radio transmitter/receiver device receives the signal from the intelligent mobile phone, the MCU processor signals the ACC power control device to conduct on the ACC power source to allow the ECU vehicle computer, the CAN, and the LIN of the vehicle to temporarily resume operation from a standby state.

8. The drive information notification system according to claim 1, wherein the MCU processor is electrically connected to an additional equipment of the vehicle and communication protocol is established between the additional equipment and the MCU processor, whereby information from the additional equipment is transmitted to the MCU processor to be processed thereby and the radio transmitter/receiver device transmits the processed information to be received by the intelligent mobile phone to allow the intelligent mobile phone to make a notification with graphics, text, or voice.

9. The drive information notification system according to claim 1, wherein the MCU processor is connected with another radio transmitter/receiver device, the radio transmitter/receiver device establishing communication protocol with respect to radio signal of an additional equipment comprising a function of radio transmission of information so that radio signal of the additional equipment is transmitted to the radio transmitter/receiver device to be processed by the MCU processor and transmitted outward by the radio transmitter/receiver device to allow a notification to be made by the intelligent mobile phone through graphics, text, or voice.
